(19) United States
(12) Patent Application Publication
(10) Pub. No.: US 2013/0246293 A1
(43) Pub. Date: Sep. 19, 2013

(54) MUSIC AND VIDEO ACQUISITION VERIFICATION SYSTEM

(71) Applicant: David Casto, Frankfort, IL (US)

(72) Inventor: David Casto, Frankfort, IL (US)

(73) Assignee: David Casto, Frankfort, IL (US)

(21) Appl. No.: 13/487,491

(22) Filed: Jun. 4, 2012

Related U.S. Application Data
(60) Provisional application No. 61/611,835, filed on Mar. 16, 2012.

(51) Int. Cl. G06Q 99/00

(52) U.S. Cl. 705/317

(57) ABSTRACT

A system and method for verifying that an individual, such as a DJ, has lawfully obtained a copy of material, such as music audio and music videos. The system and method allows potential employers to verify with an independent source that an individual has met the requisite showing to be certified. The verification/certification can be represented by a membership card, logo, identification number, or the like.

### RELATED APPLICATION

This application claims the filing priority of U.S. Provisional Application No. 61/611,835, titled “Music and Video Acquisition Verification System” and filed on Mar. 16, 2012 (the '835 application). The entirety of the '835 application is hereby incorporated by reference.

### TECHNICAL FIELD OF THE INVENTION

The present device relates to a system for verifying music and music videos have been lawfully obtained. Particularly, the present device relates to a system for verifying music audio and music video obtained by an individual, particularly a disc jockey, a video jockey, a Karaoke jockey, or the like (collectively, a “DJ” or “DJs”), has been done so in compliance with the numerous anti-piracy and copyright laws.

### BACKGROUND OF THE INVENTION

Increasingly, new legislation and existing anti-piracy/copyright laws aim to improve protection of copyright holders from those who would obtain copies of protected works from illegal sources, such as certain domestic and foreign websites and “black market” copies (a.k.a., bootleg copies). The incentive to obtain illegal copies of audio and video material may be particularly appealing where the individual derives income directly related to use of the audio and video material, such as a DJ. Such illegal downloading or uploading is typically less expensive and would allow infringing DJs to increase profits and/or under bid legitimate DJs for work. Such a system, unchecked, creates an incentive for more DJs to infringe copyright and violate anti-piracy laws.

For example, venues, such as nightclubs, banquet halls, and the like, which may regularly hire DJs for parties (e.g., bar mitzvah, wedding, birthday, anniversary, etc.) may be unaware that a particular DJ has obtained some or all of their material by illegal means. Accordingly, cost becomes a significant factor in determining who is hired. The legitimate DJ is handicapped in such a situation, because he or she may have a higher overhead cost per song/video. The result may be that illegitimate DJs get hired instead of the legitimate DJs.

Further, whether such a venue may be held liable for the infringing action of its hire is a position most owners would probably prefer not to be in. However, these venues do not have the ability to verify whether a DJ is legitimate or not.

The present system solves these and other problems associated with verifying that DJs have lawfully obtained their materials. Venues will be able to check each individual DJ quickly and easily to verify that the music and videos used have been lawfully obtained.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a schematic of an embodiment of the general system configuration;

FIG. 2 is a screen shot showing a home screen of a DJ verification website;

FIG. 3 is an illustration of one possible version of the front of a verification card;

FIG. 4 is an illustration of one possible version of the back of a verification card;

FIG. 5 is a screen shot showing a verification search screen;

FIG. 6 is a screen shot showing the results of a positive search;

FIG. 7 is a screen shot showing the results of a negative search;

FIG. 8 is a screen shot showing an embodiment of a possible certification seal;

FIG. 9 is a screen shot showing a member profile;

FIG. 10 is a screen shot showing a possible display for a non-verified DJ;

FIG. 11 is a screen shot showing a highlighted tab to begin the registration process;

FIG. 12a is a top portion of a screen shot showing possible required information for registration;

FIG. 12b is a bottom portion of a screen shot showing possible required information for registration;

FIGS. 13a-c are alternate screen shots for selection of music sources during registration;

FIG. 14 is a screen shot showing a “Terms and Conditions” agreement;

FIG. 15 is a screen shot showing a payment page;

FIG. 16 is a screen shot showing a DJ member login page;

FIG. 17 is a top portion of a screen shot showing input information;

FIG. 18 is a bottom portion of a screen shot showing input information;

FIG. 19 is a partial screen shot of FIG. 17 showing the “Upload” tab;

FIG. 20 is a partial screen shot of FIG. 17 showing another “Upload” tab;

FIG. 21 is a screen shot showing a possible certification seal for members to use on web pages;

FIG. 22 is a screen shot showing a possible certification seal and possible code for use on web pages;

FIG. 23 is a screen shot showing a possible correspondence email;

FIG. 24 is a screen shot showing an administrative web page;

FIG. 25 is a screen shot showing a web page for ordering replacement membership cards;

FIG. 26 is a screen shot showing a payment page of the system;

FIG. 27 is a screen shot showing one possible F.A.Q. page of the inventive system;

FIG. 28 is a screen shot showing an “Installer” app for a smart phone or tablet device; and

FIG. 29 is a screen shot showing a web page for reporting an unverified DJ.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to any of the specific embodiments described or illustrated.

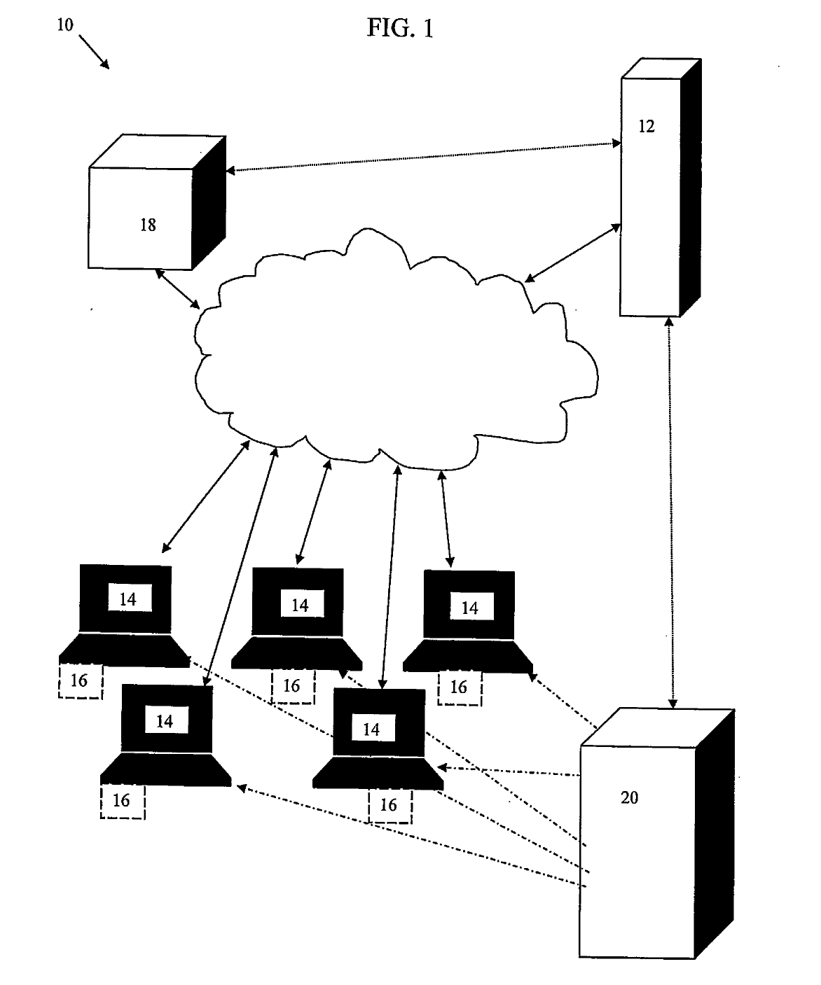

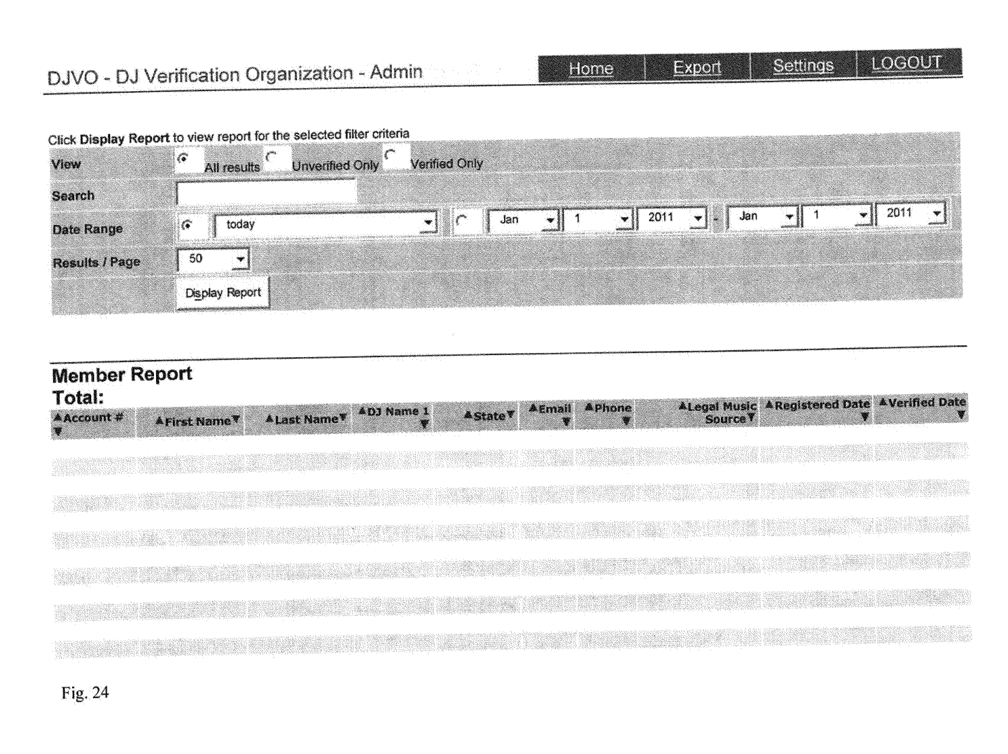

Referring to FIGS. 1-29, there is illustrated an Internet-based system for certifying that audio and video material has been lawfully obtained by individuals, such as DJs, and then certifying the individuals. Further, the Internet-based system provides verification that a particular individual has been certified. There does not currently exist a service that provides verification and certification that a DJ has obtained their music from legal sources.

By “DJ” it is meant a “Disc Jockey” including name variations such as VJ or Music Video Jockey and KJ or Karaoke Jockey. Also, the format and or source of the music audio and music video includes MP3, MP4, CD, DVD and Vinyl sources. Further, by “legal sources” it is meant that the material was obtained in a manner which is not a violation of any copyright laws. Such sources may include music subscription services, record pools, music pools, video pools, karaoke pools, DJ pools, retail stores, online music stores, promotional music delivery services or record label direct servicing.

The present system and method, as generally depicted in FIG. 1, benefit both the DJ, by helping to eliminate individuals competing unfairly in the market, as well as the potential employer/contractor, by providing an effective verification process for checking individual applicants are certified. To these ends, the present system and methods (1) help eliminate piracy/copyright infringement of music audio and music video through illegal downloading and file sharing, (2) provide certified DJs with proof that music audio and music video has been legally obtained, (3) maintain a database of purchase receipts, and (4) provide a search engine to businesses, individuals, government agencies, etc. for looking up individuals to determine whether they have been certified.

The system 10 is generally comprised of a DJ Verification server 12 having accessible memory and connected to a network, such as the Internet. A plurality of users 14 working from remote terminals are able to access the verification server 12 via the network. Each user 14 has a cache of material 16, such as audio and video music, obtained from at least one of either online material sources 18 or offline material sources 20. The system 10 is able to provide verification that the cache of material has been legally obtained, and then provide certification to that effect, as necessary.

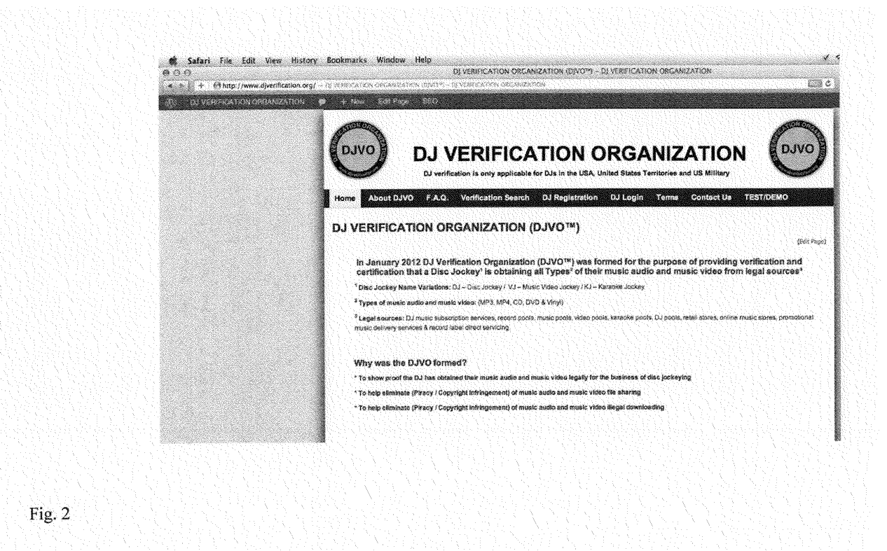

As shown in FIG. 2, the system comprises a website (e.g., http://www.djverification.org and/or http://www.djvo.org) which explains the certification process and provides the verification search, as discussed above. The content of these two websites is hereby incorporated by reference.

Certification is preferably for each individual not per company. Accordingly, each DJ from a particular company must have his or her own music and videos certified. This is beneficial to a company that may periodically hire new DJs, which might then require repeating the certification process each time, and to the DJ who may leave a company, but then still maintains certification of his or her music and videos. Preferably, DJ certification is for a fixed period of time—e.g., three months, six months, one year, three years—and must be either renewed or re-certified at the end of that period.

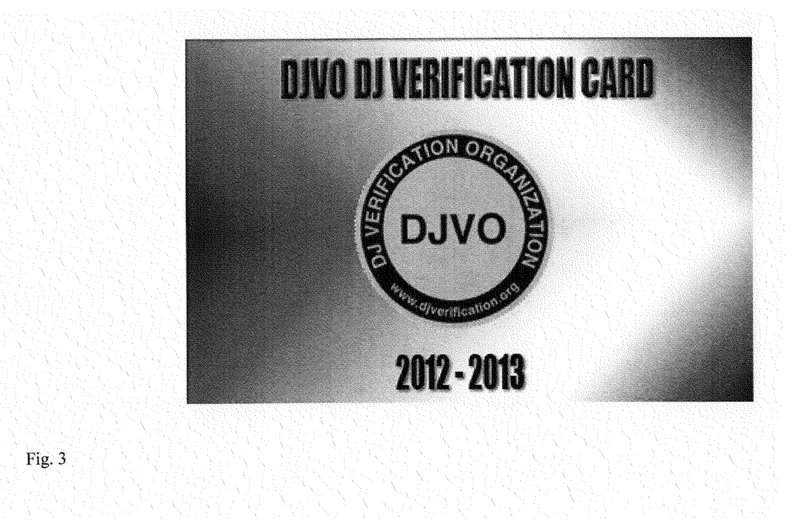

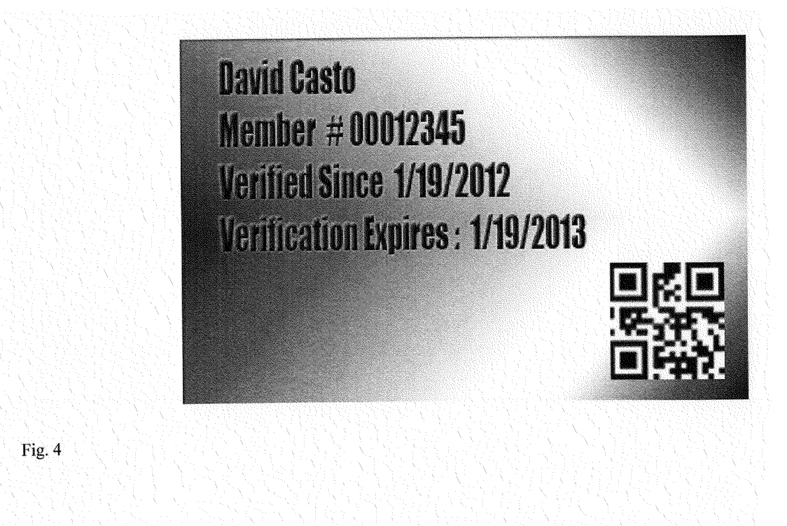

The DJ would pay a fee at the time of registering for the certification and the fee may be based on the amount of material to be checked, the source of the material, or some other factor. Once a DJs material is found to be lawfully obtained (i.e., cleared), the DJ may receive a DJ certification card similar to that illustrated in FIGS. 3 and 4. The card may be mailed or delivered electronically for downloading and printing. Preferably, the DJ certification card will display identifying information for the certified individual, including, for example, a first and last name, an account number, a certification date, a certification expiration date, a barcode, and/or a QR (quick response) Code. The certification card may even include a picture, if desired, to help prevent card sharing. Alternatively, use of a barcode and/or QR Code would allow the card to be scanned with, for example, a smart phone or code reader and could take the user (a potential employer, for example) to the verification website for a search or instantly to the certified individuals record, which may include a photo for identification.

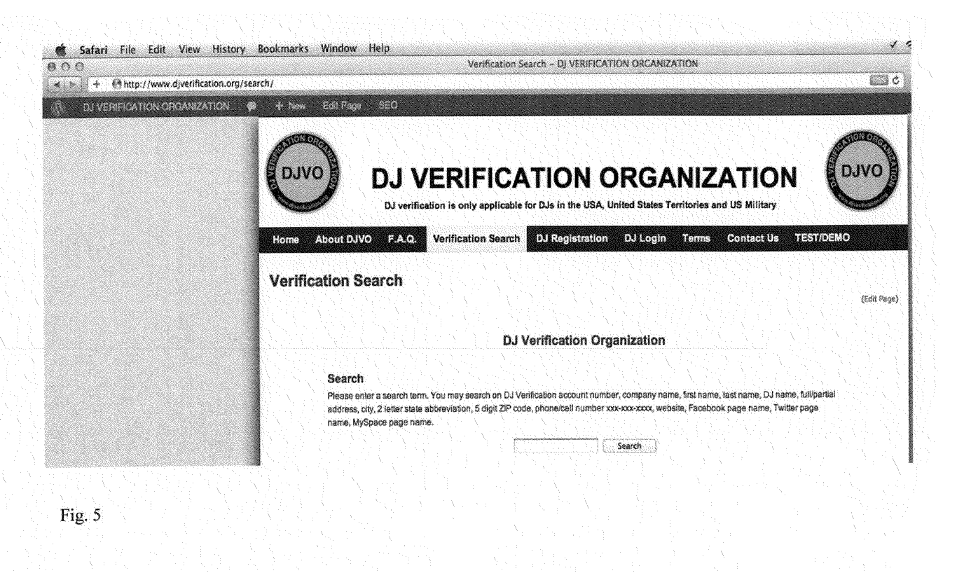

Referring to FIG. 5, where a certification card is not available, the system includes a searchable database of certified individuals to allow potential employers to verify whether an individual is certified. The system may also include a downloadable app for any smart phone, computer, or tablet device which connects the user to the searchable database of certified DJs. As illustrated in FIG. 5, a verification search may be performed using any number of possible inputs, including the following inputs for the individual being verified:

First and Last Name,

DJ Name,

Company Name,

City,

State,

Account Number,

Certification Date,

Certification Expiration Date.

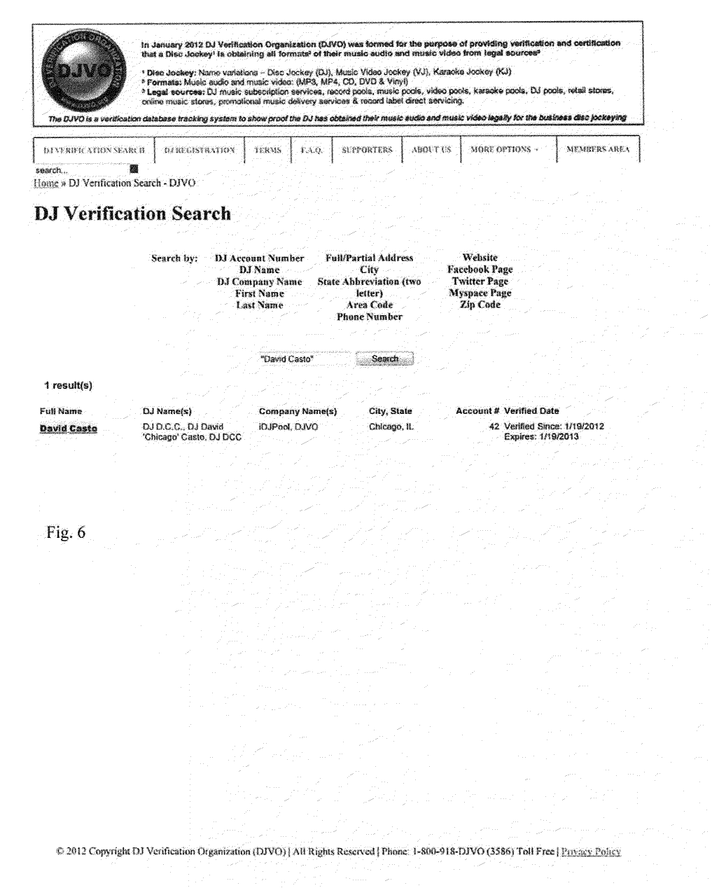

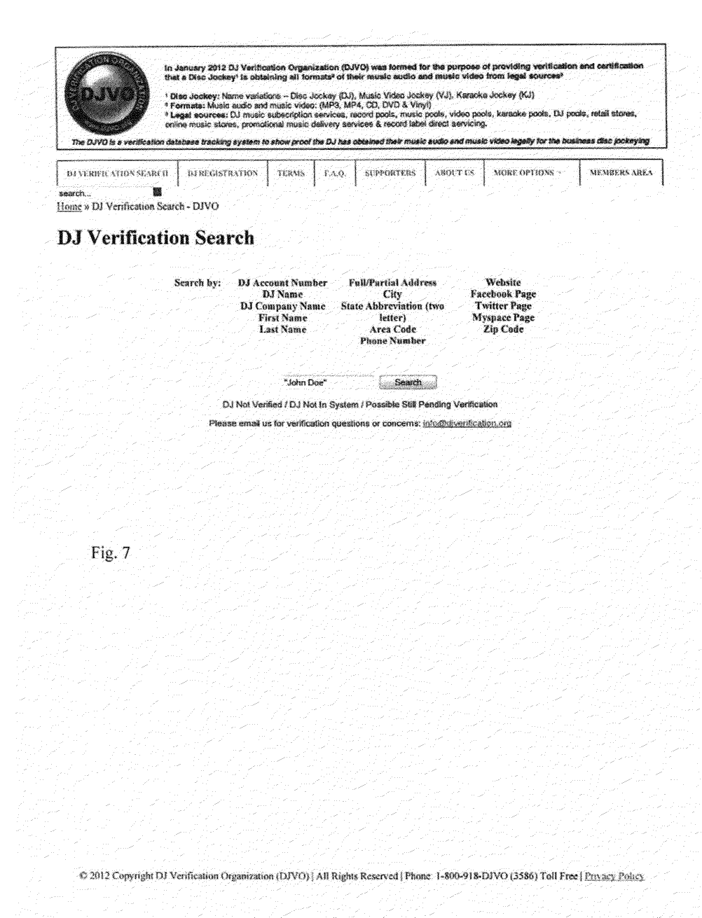

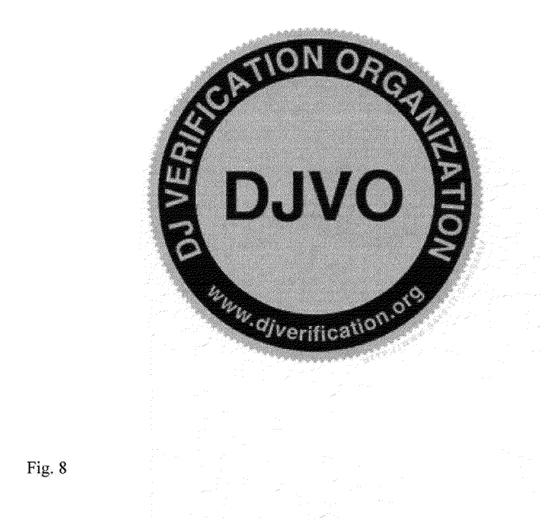

FIG. 6 illustrates a successful verification search for an individual. The successful search may immediately pull up the individual's record, which would include details about the individual possibly including a picture for identification. FIG. 7, on the other hand, is an illustration of an unsuccessful verification search. The latter result may be due to expiration of the individual's certification, denial of the individual's certification, pending certification of the individual, or no such individual on record—i.e., “DJ Not Certified/DJ Not In System/Possible Still Pending Certification”.

Where the certified individual has a website, the system may include a Certification Seal (see FIG. 8) which can be imbedded to the DJ's website or provide a hyperlink to jump a user of the DJ's website to the appropriate certification record. Again, where the company employs a plurality of DJs, each listed DJ on the website would require his or her own Certification Seal.

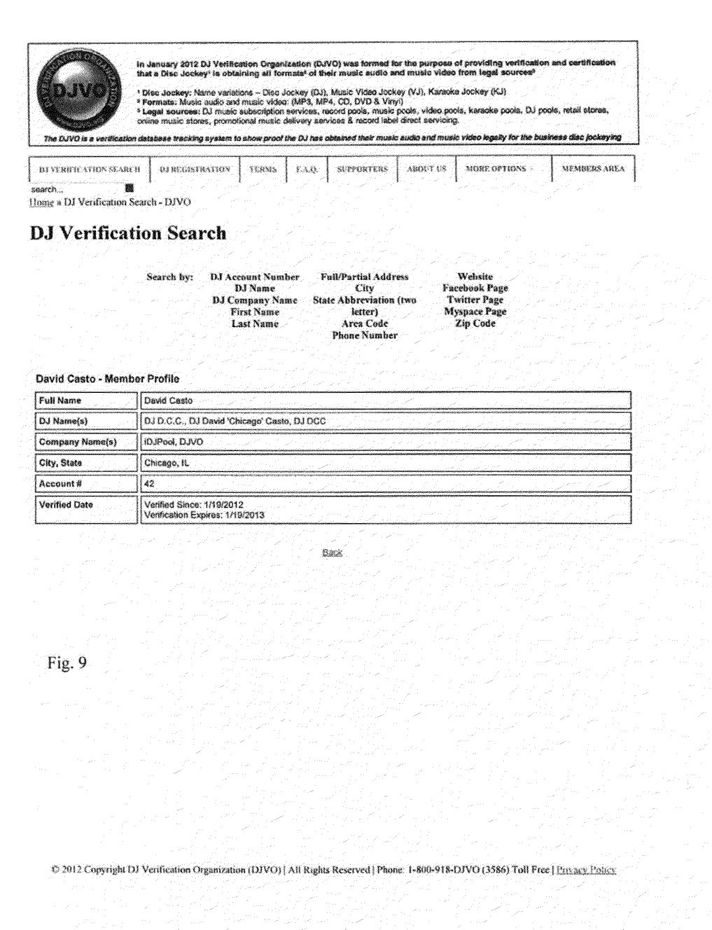

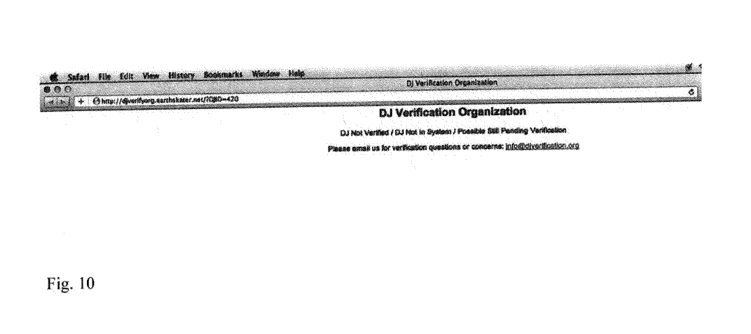

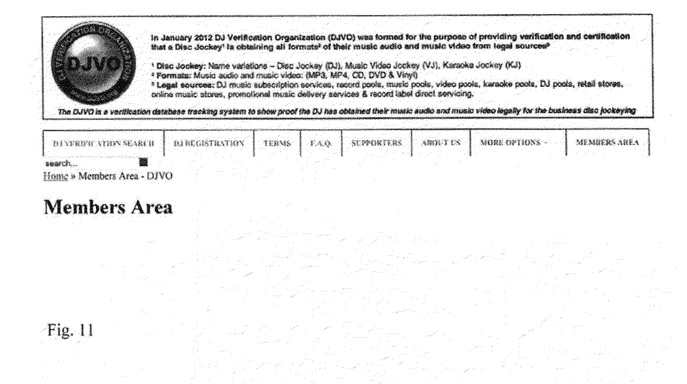

In a preferred embodiment, when the seal is installed on a certified DJ's website and clicked on by a searcher, it could display details of the certified DJ, as shown in FIG. 9, including at least one of the following: Personal Name, DJ Name, Company Name, City, State, Account No., Certified Date, Certification Expiration Date, or similar information. Obviously, if the seal is a fake, counterfeited, or expired, it will show nothing or if it is hyperlinked it may show language similar to the following: “DJ Not Certified/DJ Not In System/Possible Still Pending Certification”, as shown in FIG. 10. To control use of the certification seal, it should be provided only by the system administrator.

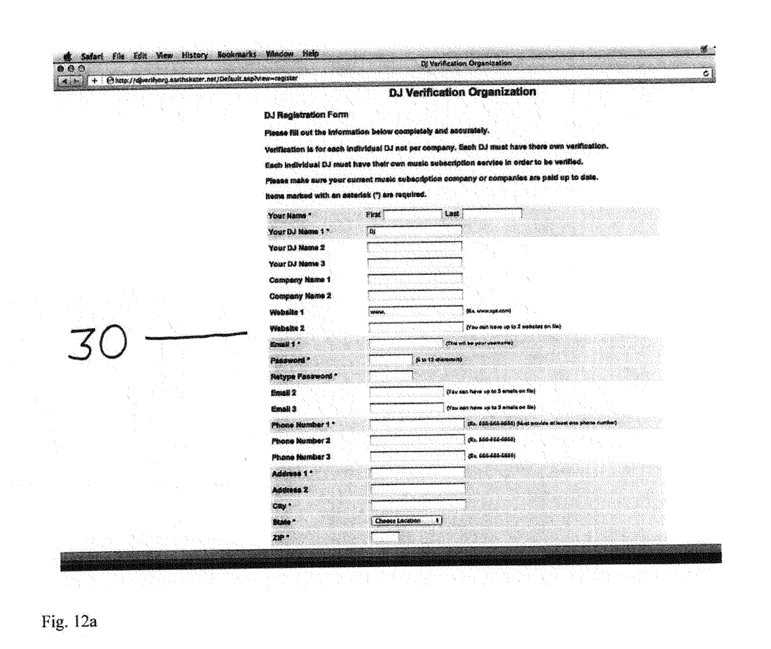

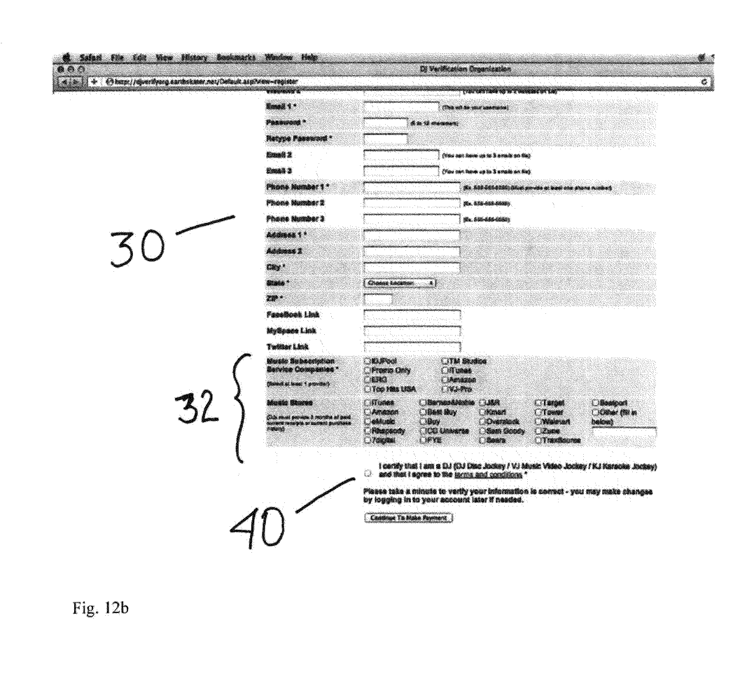

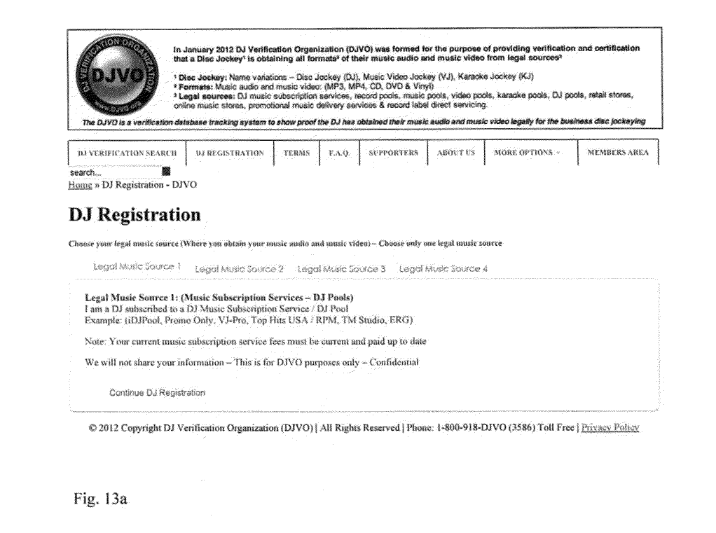

Referring now to FIGS. 11-12a/b, an embodiment of the certification process will be explained. As shown by the highlighted tab “DJ Registration” in FIG. 11, this page begins the registration process for any individual wanting to have his or her music audio and music video certified. FIGS. 12a and 12b illustrate possible information input screens where identifying information on each individual is collected. For the preferred embodiment, as shown in section 30 of FIGS. 12a and 12b, the collected information might include the following details:
1. First Name—Last Name
2. DJ Name 1
3. DJ Name 2
4. DJ Name 3
5. Company Name 1
6. Company Name 2
7. website www 1
8. website www 2
9. email address 1 (may be the username for the login page)
10. Password (may be the password for the login page)
11. additional email address 2
12. additional email address 3
13. Phone Number 1 (area code) xxx-xxxx
14. Phone Number 2 (area code) xxx-xxxx
15. Phone Number 3 (area code) xxx-xxxx
16. Address (2 Lines)
17. City
18. State
19. Zip Code
20. County
21. Facebook page link
22. Myspace page link
23. Twitter page link

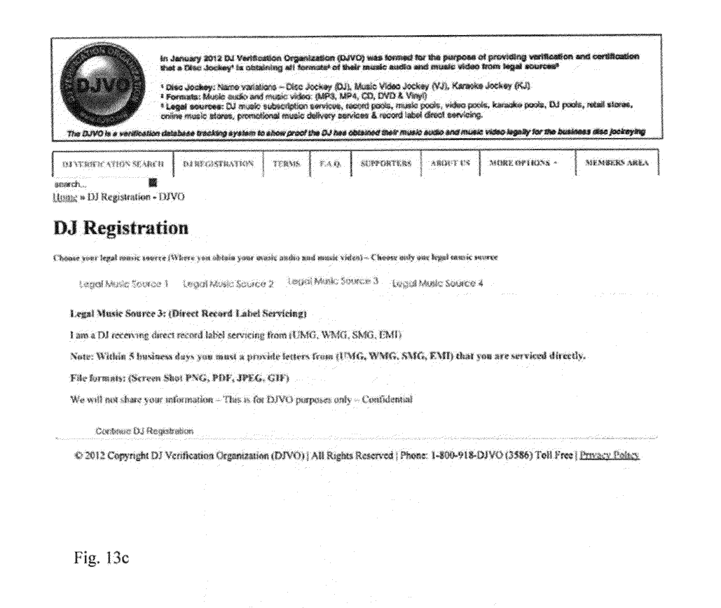

Obviously, the list of information could be expanded or contracted, as desired. Further, once saved to the system memory, the information (e.g., email, home address, phone number, etc.) may be added to or changed. In some cases, multiple entries may be made, such as DJ names, affiliated websites, phone numbers, and the like. By checking the “I agree” box at the bottom of FIG. 12b, the individual may then be taken to a payment screen, for example. As part of the “I agree” box statement, a link to the system's “Terms of Use” or “Terms and Conditions,” as shown in FIG. 14, may be used.

As previously stated, it is desirable to mandate certification on an individual basis rather than by groups. However, there may be situations where “group membership” may be advantageous or preferred.

Referring back to FIG. 12b, if the DJ is subscribed to a DJ music subscription service, then the DJ may choose from a list of legal music sources at section 32. Currently, eight on-line services are recognized. Obviously, additional services may be added and others removed from the list, as necessary. In the present embodiment, the following music audio and music video subscription services are listed:

| | |
|---|---|
| iDJPool | TM Studio |
| Promo Only | iTunes |
| ERG | Amazon |
| Top Hits USA | VJ-Pro |

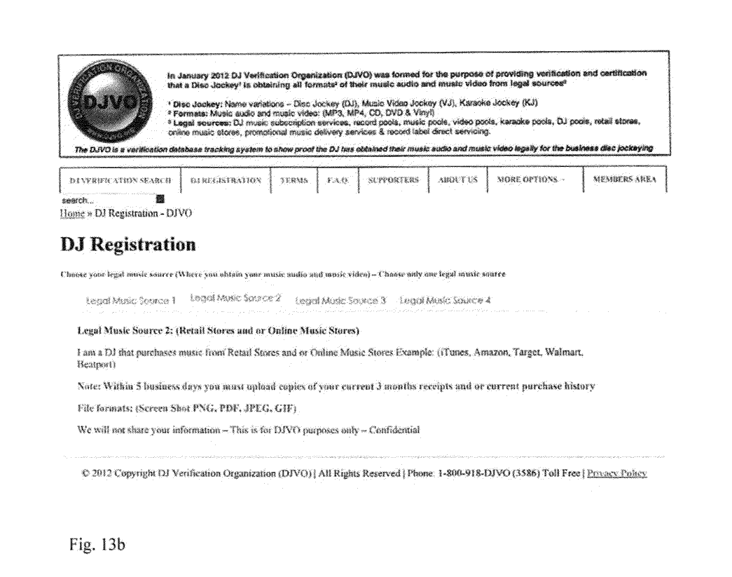

FIGS. 13a-c illustrate alternate registration web page for selecting music sources. As shown, the selection is divided into three possible sources including (1) music subscription services, (2) retail stores and/or online stores, and (3) direct record label servicing. Each possible source provides a list of providers and may also provide details regarding uploading purchase history information or the like.

As membership and download histories can be obtained from these subscription services, a DJ that does belong to any of these services would not have to provide further evidence of purchase history (e.g., three months of paid current receipts). However, as an added benefit, the website may allow a DJ to upload any video or music receipts or purchase history information to be added to their account. This information can be stored indefinitely.

If a DJ applicant chooses one or more music subscription services from section 32 as a service to which they are currently subscribed, then contact (preferably by email) will be made with each of the selected subscription services. Contact information, including phone numbers and email addresses, for each listed service will be maintained by the certification website.

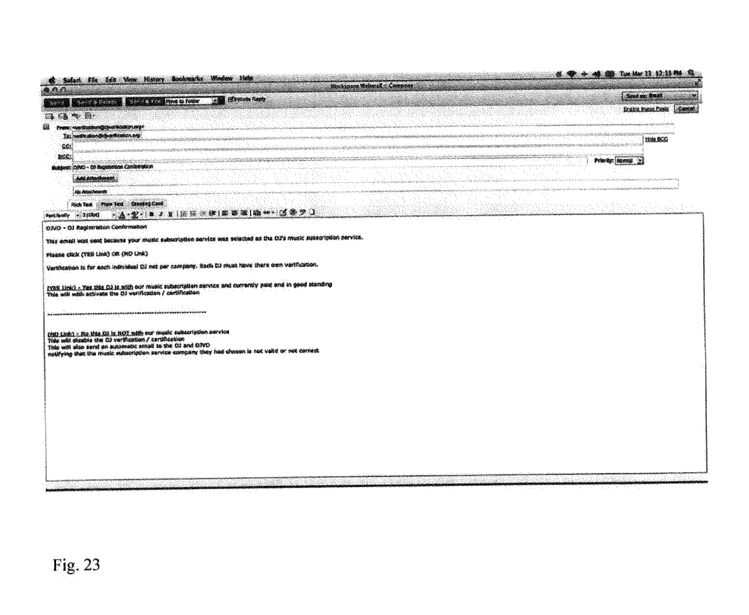

FIG. 23 illustrates a possible email for sending to a subscription service. The email could be sent to each selected music subscription service company could provide pertinent information on the DJ applicant, via attachment or hyperlink to the certification website. As shown, the email would identify the applicant and note that the subject subscription service was selected as a paid music subscription service for the DJ.

The email will ask the music subscription service company to respond back by clicking one of either a “YES” link or a “NO” link in the email. If the service clicks on the “YES” link, then the DJ applicant's certification will be “activated.” If the service clicks on the “NO” link, then the DJ applicant's certification will be “denied.” A follow up email or letter may be sent or call made to the DJ to advise that the chosen music subscription service company was either not valid or incorrect. The certifying service may then contact any DJ applicant where a “not valid or incorrect” music subscriptions service is selected in order to get the matter corrected.

Where a DJ does not belong to a recognized music subscription service and purchases music audio and music video from retail stores and/or online music stores, an option exists to allow the DJ to choose from a list of legal music sources in section 32 from which they obtained their music audio and music video. A sample list of some recognized retail and on-line music sources may include:

7digital
Amazon
Barnes & Noble
Beatport
Best Buy
Buy
CD Universe
emusic
FYE
iTunes
J & R
Kmart
Overstock
Rhapsody
Sam Goody
Sears
Target
Tower
Traxsource
Walmart
Zune

An additional option in section 32 may be “Other” to allow the DJ applicant to enter the name of a retail music store where music audio and/or music video was obtained.

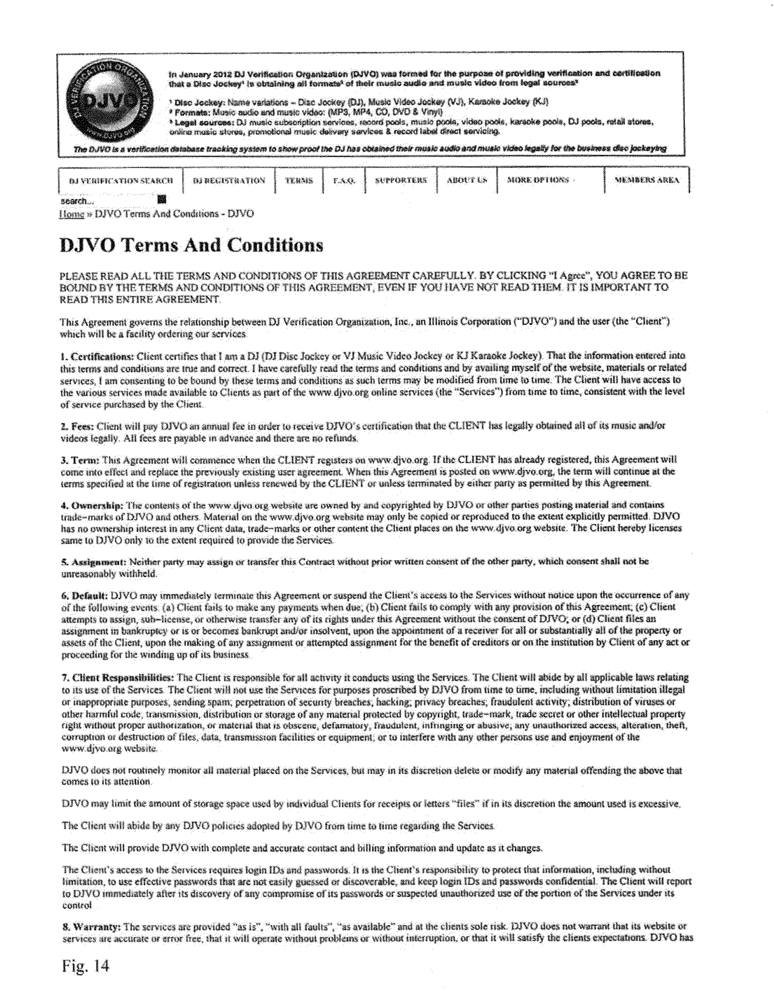

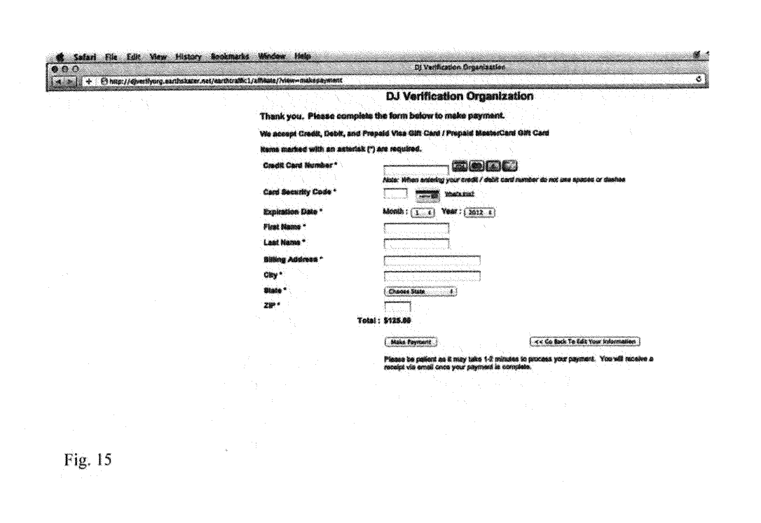

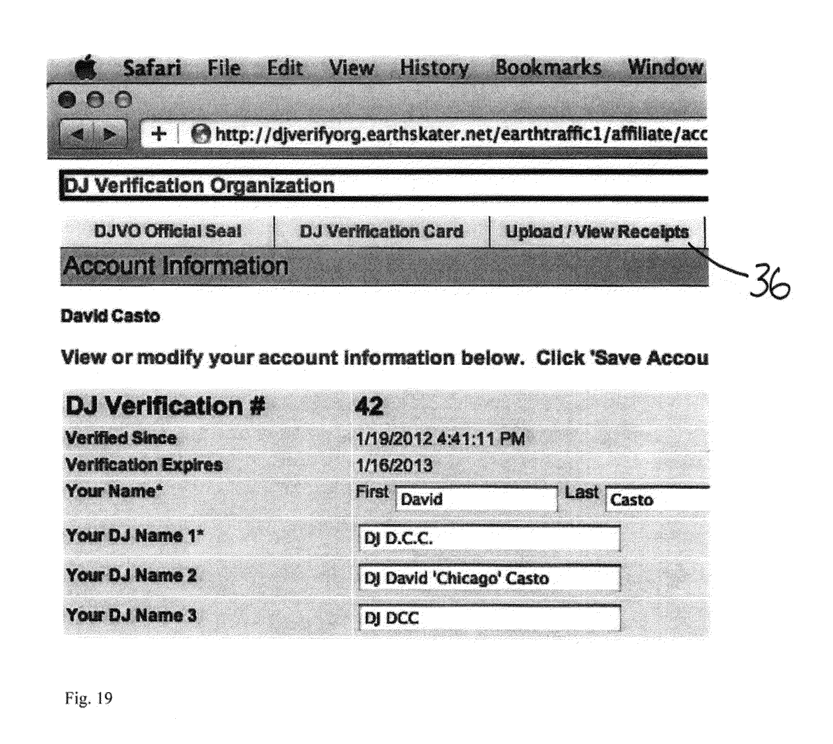

A DJ which obtains music in this manner would be required to provide, for example, anywhere from one to six months of paid receipts or an up-to-date purchase history within five days after completing the DJ registration. The receipt requirement is preferable three months, but may be adjusted as necessary. The receipts should match up with the retail stores selected in section 32. To provide such confirmation information, once a DJ has completed the on-line registration and paid any requisite fee (see FIG. 15), the DJ must log into the account created within a set period (e.g., five days) and upload copies of the required receipts or purchase history in the form of a screen shot, or any of the following file types: PNG, PDF, JPEG, GIF. The “upload/view receipts” tab 36 is shown in FIG. 19. These receipts may be stored by the verification site for a time period, e.g., seven years.

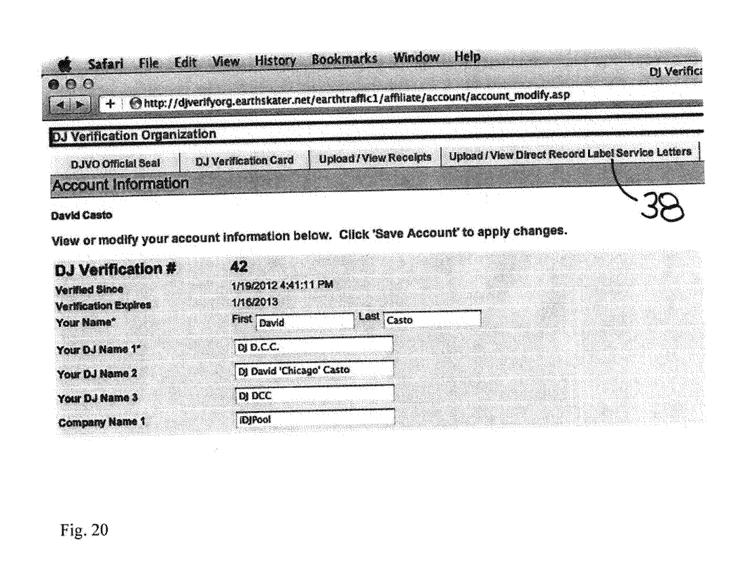

In an alternative scenario, a DJ may have a direct servicing contract with a particular record label. In such a situation, in lieu of receipts, the DJ applicant would be required to provide letters from each record label (e.g., UMG, SMG, WMG) or a promotional music delivery service (e.g., Play MPE, New Music Server, Digital Media Distribution System (DMDS), Digital Direct Server (DDS)). As shown in FIG. 20, a “upload/view direct record label service letters” tab 38 can be used to upload and store letters in a manner similar to the receipts and history, discussed above.

Once the receipts, letters, and/or history are uploaded to the website, the certification process begins with a review of all pertinent information (e.g., number of songs purchased, format details, purchase date(s), payment details, agreement details, etc.). A decision on each DJ applicant can then be made to either certify the DJ, reject the DJ, or to request more information from the DJ applicant. Where all purchased music, audio and video, can be certified as legally obtained by the DJ applicant, then certification should be awarded. The uncovering of any unlawfully obtained music should result in a denial of certification. All other scenarios would likely result in a request for additional information. The certification process may take a considerable amount of time, as much as seven days under current normal circumstances.

By checking the box 40 (FIG. 12b), the DJ applicant may certify that the information they entered is correct. An exemplary “Terms and Condition” clause 42 is shown in FIG. 14. Once payment is complete (see FIG. 15), the DJ can be sent (via email, for example) a copy of their DJ registration forms and payment receipt.

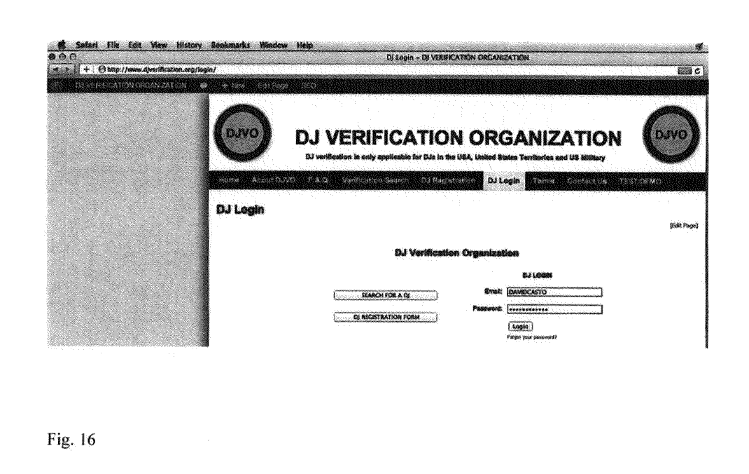

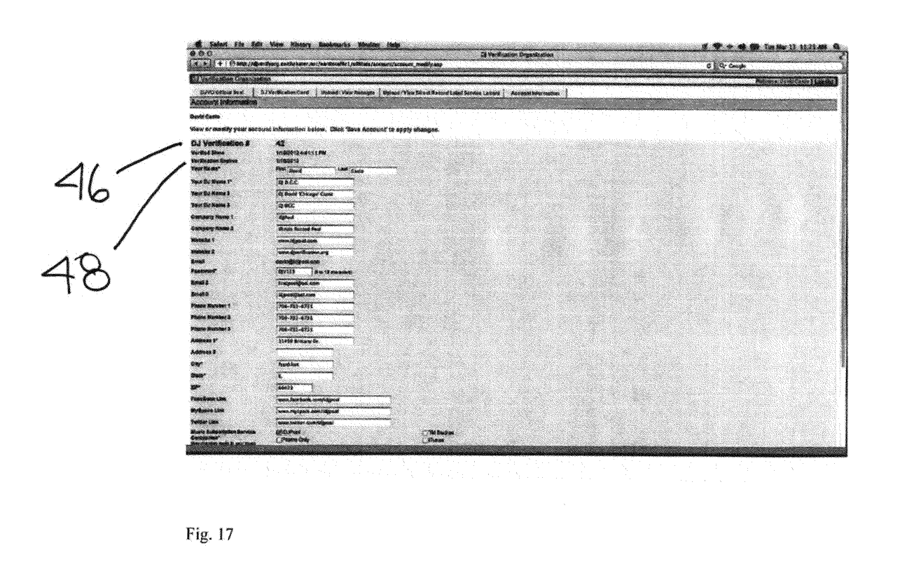

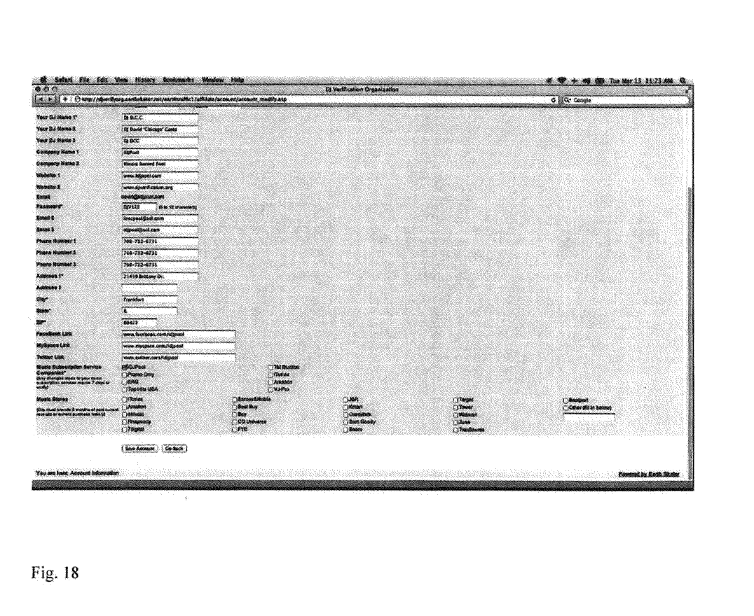

As shown in FIG. 16, once an account is created, the DJ applicant can “login” to make changes or additions to the information previously submitted. The login may require the “username” and “password” entered in section 30 on the page illustrated in FIG. 12a. Logging in will bring up the screen illustrated in FIGS. 17 and 18, where the DJ may change, add, or update information. This feature can be used at any time after an account has been created. The DJ account number 46, and certification expiration date 48 are also prominently displayed on this page.

Some changes to a DJ's account may require re-certification of a DJ applicant. For example, if a previously certified DJ changes to or adds a music subscription service (see section 32 of FIG. 12b), an email, as shown in FIG. 23, could be sent out to the added music subscription company asking for verification of the DJ applicant. The email could provide a simple “click” to verify or may require additional steps to verify that the DJ applicant is a member of that music subscription service. Such changes may take up to seven days for re-verification.

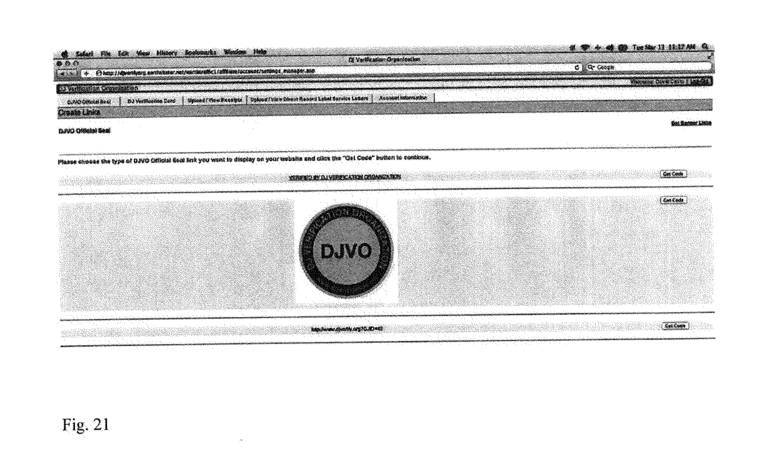

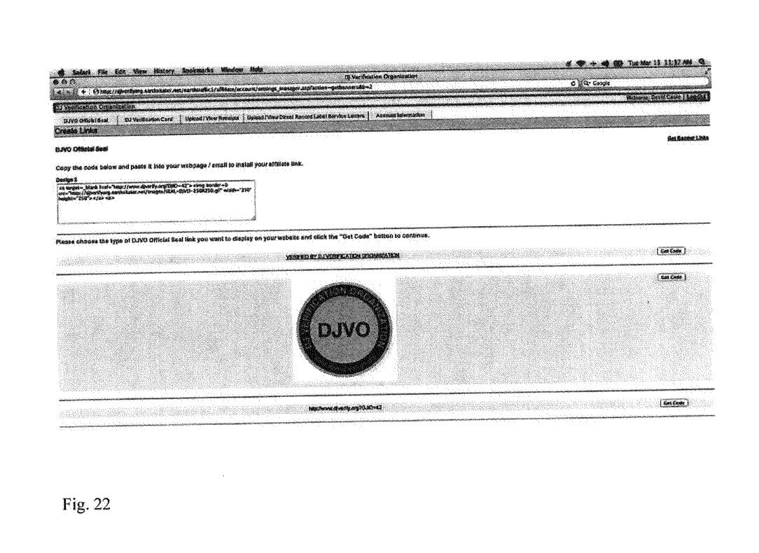

As an added benefit and to signify certification, referring to FIGS. 21 and 22, a certified DJ may be given access to a website code which may be used to install an “Official Seal” or similar certification mark as proof of the certified DJ's status. The certified DJ may be provided with several seal designs from which to choose. Once installed, the seal might provide a hyperlink to an abbreviated display of the approved DJ's name, membership no., status date, and other pertinent information. Alternatively, the seal may provide such information when the user places the cursor over the seal. Either method will help a user to be sure the seal is genuine and for a particular DJ.

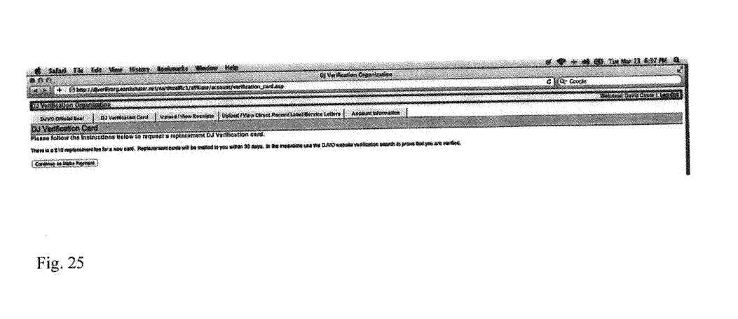

Another feature of the certification site is an administration login page, as shown in FIG. 25. This page allows administrators of the website to enter the and view the storage database of all the registered DJs, including receipts, letters and any other uploaded proof of purchase information. The administrator may also update and correct any information within the website database. Reports (e.g., statistical, geographic, etc.) may also be generated from this administration site. Finally, in the event that any certified DJ is found to be in violation of the certification requirements (e.g., use of unlawfully obtained music), an administrator can decertify the DJ through the administration website.

Still another feature of the service includes a search feature for businesses, individuals and government agencies. The search feature, as shown in FIG. 16, is accessed at the DJ login page by clicking the “Search For A DJ” button. Verification searches are available to business, personal and government agencies that need to determine if a DJ is certified or not. The search may be performed using any of the criteria listed in FIG. 12. However, for privacy reasons, a limited amount of the information will be displayed to the searcher. For example, the results of a search might list the following information:
1. First Name—Last Name
2. City And State
3. DJ Name 1
4. DJ Name 2
5. Company Name 1
6. Company Name 2
7. DJVO Account Number
8. Certified or NOT Certified
9. Certification Issue Date
10. Certification Expiration Date

If no corresponding certified DJ is found in the system, then at least one of the following messages may be displayed: “DJ not Certified” where the DJ's certification has been rejected; “DJ not in the System” where no records match the search query; or “Certification still pending” where a match may be found, but the certification is not complete.

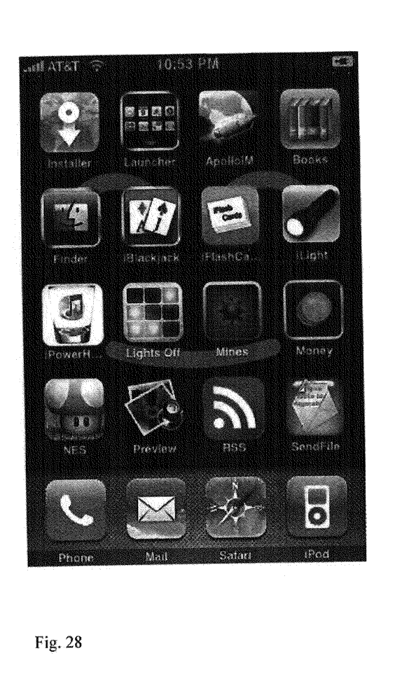

A smart phone app may also be provided, as shown in FIG. 28. The downloadable search/lookup database app may be available for all smart phones and tablets and would be useful for determining if a DJ is certified or not without the use of a standard desktop or laptop computer. Similar search features as the website version would be made available through the smart phone/tablet app.

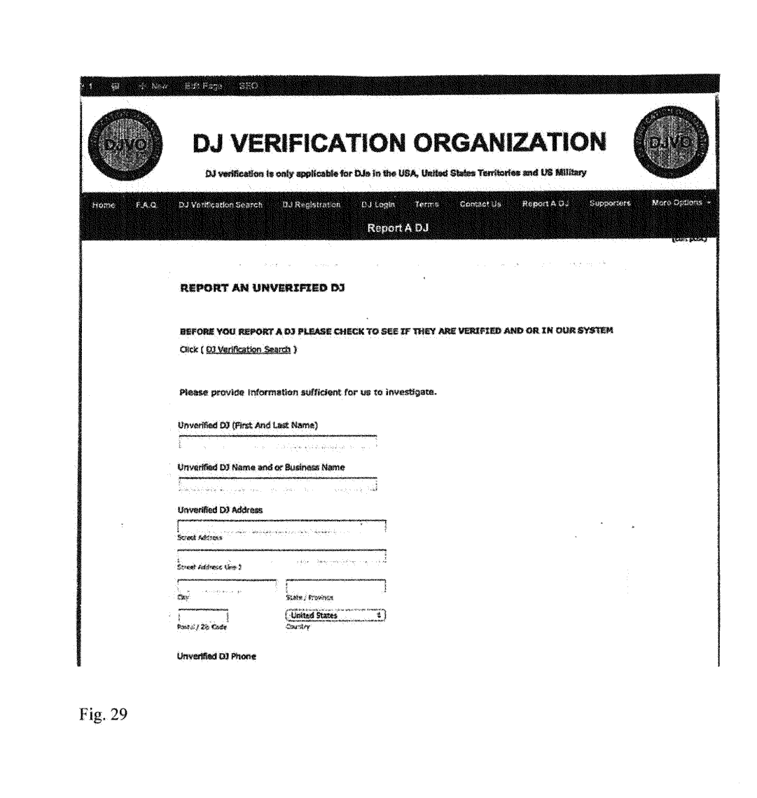

An optional feature of the method may include the opportunity to report a non-certified DJ. With reference to FIG. 29, a web page illustrates how information about a DJ can be entered to the system after it has been determined that a DJ has not been certified or where someone suspects a DJ is using a non-legal source for obtaining music. The system can collect such information and report the DJ to authorities and/or maintain a record for future attempts by the DJ to register for certification.

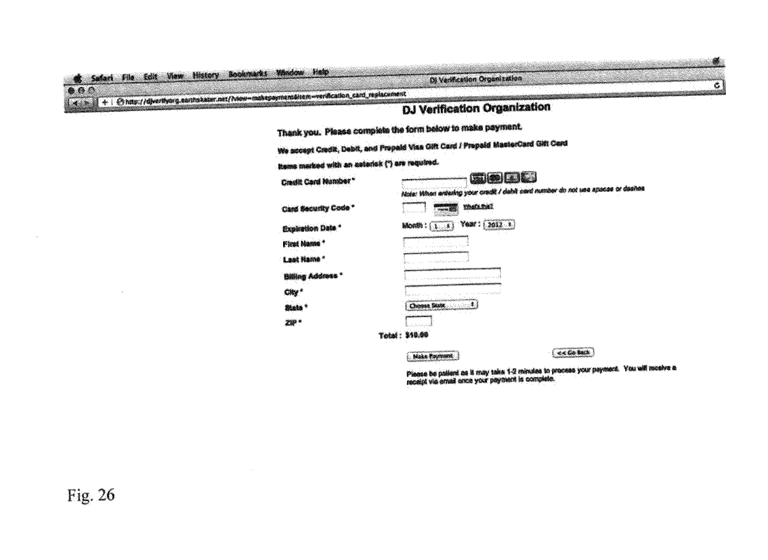

FIGS. 25 and 26 illustrate a webpage where a certified DJ can request and pay for a replacement certification card. The applicant may be charged a nominal fee (shown as a $10.00 replacement fee) for a new card. Replacement cards would be mailed to the mailing address on the account of the requesting DJ. Without a card, a certified DJ would need to prove certification through use of the website DJ verification search.

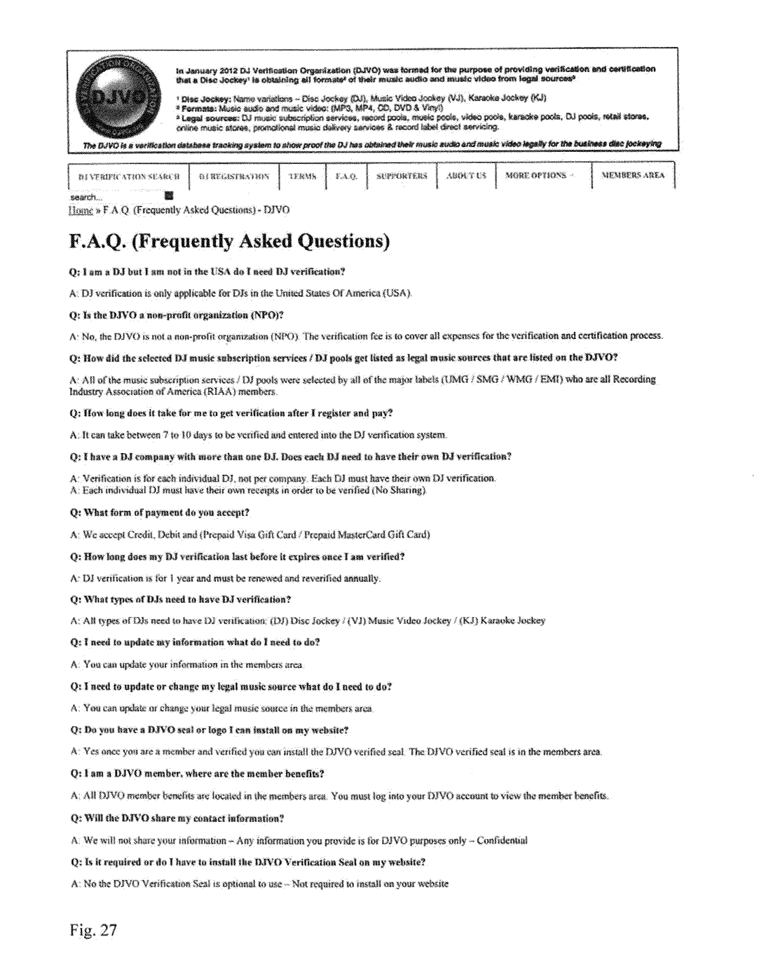

FIG. 27 gives an exemplary list of frequently asked questions (F.A.Q.), including the following:
Q: I am a DJ but I am not in the U.S. Do I need to be certified?
A: No, DJ verification is only applicable for DJs in the U.S., U.S. Territories or in the U.S. Military.
Q: How long does it take to get certified after I register and pay?
A: It can take up to 7 Days to be certified and entered into the DJ verification system.
Q: I have a DJ company with more than one DJ. Does each DJ need to have their own DJ certification?
A: Yes, certification is for each individual DJ, not per company. Each DJ must have their own DJ certification.
Q: What form of payment do you accept?
A: We accept Credit, Debit and Prepaid Visa or MasterCard Gift Card.
Q: I have a DJ company with more than one DJ. Does each DJ need to have their own music subscription service membership for certification?
A: Yes, each individual DJ must have their own music subscription service in order to be certified.
Q: How long does my DJ certification last before it expires once I am certified?
A: DJ verification is good for one full year, but must be renewed annually and may require recertification with the change in, for example, music subscription services.
Q: What type of DJ needs to have DJ certification?
A: All DJs need to be certified, including: Disc Jockey (DJ), Music Video Jockey (VJ), and Karaoke Jockey (KJ).
Q: Do I get a DJ certification card once I am certified?
A: Yes, within approximately 30 days after certification you should receive a DJ certification card with your name, account number and expiration date. The DJ certification card will be mailed to the address on your account.
Q: Will I get a new DJ certification card every year?
A: Yes, each time you renew or are re-certified, you will receive a new DJ certification card with your name, account number and expiration date. The DJ certification card will be mailed to the address on your account.
Q: I lost my DJ certification card. What do I need to do and is there a cost to replace it?
A: To replace a lost DJ certification card go to the DJ Login section and click on “Replacement DJ verification Card.” There is a $10 replacement fee for a new card. Replacement cards will be mailed to you within 30 days. In the meantime, you can use the website DJ verification search to prove you are certified.
Q: I need to update my information or music subscription company. What do I need to do?
A: Go to the DJ Login section on the website to update or modify your information.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A method for verifying an individual has lawfully obtained copies of protected material, the method comprising the steps of:
compiling a list of legitimate material sources;
storing the list into a computer system memory;
allowing a user to request verification of materials as being legally obtained;
displaying the list of legitimate material sources to the user requesting verification;
selecting from the list, by the user, at least one material source through which the user obtains material;
confirming each user selected material source as a provider of material for the user; and
assigning a unique code to the user, only if each selected material source is confirmed.

2. The method of claim 1, wherein the step of allowing a user to request verification comprises the steps of:
creating an account for each user on a verification system; and
storing account information for each user.

3. The method of claim 1, wherein the step of confirming each user selected material source as a provider of material for the user comprises the steps of:
logging into the created account for the verification system; and
uploading required purchase information to the verification system.

4. The method of claim 3, wherein the step of uploading required purchase information comprises uploading at least one purchase receipt.

5. The method of claim 3, wherein the step of uploading required purchase information comprises uploading a purchase history.

6. The method of claim 3, wherein the step of uploading required purchase information comprises uploading at least one authorization document.

7. The method of claim 1, wherein the step of confirming each user selected material source as a provider of material for the user comprises the steps of:
sending a communication inquiry to each selected material source; and
receiving a communication answer from each selected material source.

8. The method of claim 1, wherein the list of legitimate material sources comprises music subscription services.

9. The method of claim 8, wherein the materials comprise audio music and video music.

10. The method of claim 4, wherein the list of legitimate material sources comprises retail stores.

11. The method of claim 6, wherein the list of legitimate material sources comprises record label companies and promotional music delivery services.

12. The method of claim 1, wherein the system is a web-based program.

13. The method of claim 1, wherein the unique code is a user identification number.

14. The method of claim 1, wherein the unique code is a certification number.

15. A method for verifying online that an individual has lawfully obtained copies of protected audio material, the method comprising the steps of:
compiling a list of legitimate sources for obtaining audio material;
storing the list into a computer system memory;
allowing a user having a cache of audio material to request verification of the materials as being legally obtained;
displaying the list of legitimate sources to the user requesting verification and allowing the user to indicate at least one of the sources as a provider of audio material in the cache of audio material;
confirming audio material in user's cache has been provided by at least one of the legitimate sources; and
assigning a unique code to the user, only if all audio material in cache is confirmed as being provided by a legitimate source.

16. The method of claim 15 wherein the step of allowing a user to request verification comprises the steps of:
creating an account for each user, via computer, on a verification system stored on server memory; and
storing account information for each user in memory associated with the verification system.

17. The method of claim 16, wherein the step of confirming audio material comprises the steps of:
logging into the created account, via computer, for the verification system; and
uploading required purchase information to the verification system.

18. The method of claim 17, wherein the step of uploading required purchase information comprises uploading at least one purchase receipt.

19. The method of claim 17, wherein the step of uploading required purchase information comprises uploading a purchase history.

20. The method of claim 17, wherein the step of uploading required purchase information comprises uploading at least one authorization document.
